(19) United States
(12) Patent Application Publication
(10) Pub. No.: US 2002/0073079 A1
(43) Pub. Date: Jun. 13, 2002

(54) Method and apparatus for searching a database and providing relevance feedback

(76) Inventor: Merijn Terheggen, Berkeley, CA (US)

Correspondence Address: Mitchell S. Rosenfeld, Esq., c/o Gregory Scott Smith, Esq., Suite 317, 3900 Newpark Mall Road, Newark, CA, 94560, US

(21) Appl. No.: 09/736,946

(22) Filed: Dec. 13, 2000

Related U.S. Application Data
(60) Provisional application No. 60/194,669, filed on Apr. 4, 2000.

(51) Int. Cl. G06F 7/00

(52) U.S. Cl. 707/3

(57) ABSTRACT

A method and search apparatus for searching a database of records organizes results of the search into a set of most relevant records and generates a set of meta-data elements (usually keywords) enabling a user to obtain with a few mouse clicks (iterative system) only those records that are most relevant, and providing the user with feedback on what meta-data elements are relevant to the users search. In response to a search instruction from the user, the search apparatus searches the database, which can include Internet records, premium content records (or any other set of labeled information records) to generate a search result list representing a selected set of the records. The search apparatus also generates a set of most relevant meta-data elements.

### CROSS REFERENCE TO RELATED APPLICATION

This application claims priority from Provisional Application Serial No. 60/194/669, filed Apr. 4, 2000, the full disclosure of which is hereby incorporated by reference.

### FIELD OF THE INVENTION

The present invention relates generally to a database and a method and apparatus for searching such a database. More particularly, the invention relates to a method and search apparatus for searching a database comprised of both Internet and premium content information (or any other set of labeled information records).

### BACKGROUND OF THE INVENTION

1. The Prior Art

According to a study by the NEC Research Institute, conducted at the beginning of 1999, the internet at the time consisted of a total amount of 800 million publicly accessible pages containing 180 million images. The same study estimates that the total amount of publicly accessible pages in 2003 will be at least 2 billion. To find their way through this enormous collection of information, users often use one of several search-services available on the Internet.

However, search-services suffer from a host of problems that limit their usability and effectiveness in assisting people to find what they are looking for. These problems stem from the method employed by search-engines to build their document databases, and from the way in which people perform a search.

There are two basic methods used by search-services to gather information and build their database, each with their own problems. The first method is to classify documents automatically using a classification algorithm. Such an algorithm tries to determine the subject of a document by processing the document's content. The second method is to let humans (usually a staff of editors) determine the subject of documents and add them to a database.

Although the first method can result in a very large database, the database is usually of marginal quality. This is due to the fact that automatic algorithms are notoriously incapable of accurately determining a document's subject.

The second method yields a high-quality database, but the staffs of search-services are unable to keep up with the growth and size of the Internet. Even the most successful and largest venture in this category (The Open Directory Project) contains no more than a fraction of the total amount of information available on the Internet.

Apart from the difficulties in creating a database that is both complete and of a high quality, existing search-services have dated methods of performing searches. The scientific community that researches the field of Information Retrieval has long since improved and replaced these methods. Generally speaking, Information Retrieval (“IR”) concerns itself with finding specific information in a collection of data/documents. This includes for example systems to search through library catalogues, scientific databases or, indeed, the Internet.

One of the most prominent developments in IR is the use of Relevance Feedback (“RF”). RF is a general term used to indicate any process (with or without interaction with the user) that uses the results of a query to construct a new, more refined, query.

There are several ways to generate RF for an IR-system. A completely automatic system can perform a query and from the results of that query extract the most relevant words/terms, the top 10 or 20 of which can then be added to the query. An interactive model can for example require a user to select one or more documents in the query-result that are relevant to the user's information need, and use these documents to determine the most relevant terms.

Many systems that employ Relevance Feedback have been developed and tested, mainly for research purposes. Relevance Feedback was introduced in the early 1970s to optimise the performance of Information Retrieval systems. Despite the success of RF in academic and research settings, there are few public or commercial systems that offer the use of RF. Some researchers point out problems with the implementation of such large-scale systems, such as complexity and unexpected user-behaviour.

At present, an Internet search-engine employing a system that could be classified as a true RF system is provided by Northern Light. The Northern Light system groups documents that are relevant to a query into candidate categories. The most relevant candidate categories are then presented to the user for selection. Selecting categories is an efficient form of RF, because with a single mouse-click, a user can mark an entire group of documents as relevant to his information need. In many systems, a user must select multiple separate documents, or parts of documents, to provide RF to an IR-system. The system then determines relevant terms in these documents and uses those terms to expand the query.

2. Comparison to Present Invention

The present invention is a variation of Relevance Feedback, which features certain extensions. While traditional RF is only concerned with the actual content of documents, the present invention utilizes “Meta-data.” This is data about a document, and can describe the content of a document, but also the author, length, size, publisher, date of publication and any other piece of information about the document. This allows the expansion from text-only to any type of content. No IR system in existence today produces meaningful RF when dealing with a picture, a movie or a song. The present invention deals with meta-data, which can be applied on any type of information, text-based or not. The user produces Relevance Feedback by marking one or more meta-data elements as relevant to his information need. This extension of classic RF is inspired by the realization that the content of a document does not necessarily determine a document's relevance to a user's information need. This is especially true for Internet documents, which tend to contain less and less text, but more images and other non-text content instead.

A limited form of relevance feedback known as “related searches” is provided by Internet search-engines like Hotbot and Altavista. In these implementations, if a user searches for “food”, he is presented with a list containing often occurring combinations with the word food, like “Italian food” etc., etc. It will not, however, offer query extensions that may be relevant to “food”, but do not occur in combination with that word, such as, “cooking”, “restaurants”, “cutlery” and the like. The present invention has no such limitations, and in the preceding example a search would also produce terms like “wine”, “dining” and “desserts.”

Also, the level to which these systems produce meaningful results is disappointing. Again using the preceding example, “food” can be extended only twice. After that, no more “related searches” are available. The present invention dynamically generates possibly relevant query expansions, and offers up to fifteen expansions or more, depending on the maximum number of keywords allowed for a record.

### SUMMARY OF THE INVENTION

The present invention features a database and a method and apparatus for searching the database, which can include Internet and premium content records or any other set of labeled information records (like machine parts in a factory or project information in a consultancy firm). The invention provides users with access to information on the Internet or to premium content information on local networks, and the like.

The invention is especially useful in environments with large numbers of different documents or entries. The invention uses sophisticated relevance rating algorithms and methods to provide meaningful relevance feedback information about the current query in the form of a set of relevant meta-data elements (usually keywords). This relevance feedback information is presented to the user as a small list that includes only the most relevant N meta-data elements. N stands for the number of elements shown and has a value between 0 and for instance 50. The invention also generates a relevance-ranked list of records that match the query.

The invention consists of both a database and a mechanism/method to select and sort information from this database. The database is based on data structures that are specifically designed and constructed to meet the specifications and conditions set by the mechanism/method that selects and sorts the information from the database.

Except for the records, the database includes meta-data attributes. It contains meta-data about every individual record, about the individual elements a record consists of and about individual sets of records.

In response to a query/user request, the apparatus selects and sorts a set of records and a set of items that provide the user with feedback on what is relevant to his query/user request. These items can consist of meta-information like: author, keywords, subject, type, source, language characteristics, etc., etc. The apparatus can also easily use other types of meta-information, such as the length of a song, the resolution of an image, the price of an item, the expiration date of an item or document, etc. Usually the user is provided with the keywords most relevant to his/her query/user request. The set of records is ranked according to relevance to the users query/user input.

The mechanism/method uses the weights of the meta-data attributes associated with the records to determine the relevance records and meta-data elements have to a query/user request.

The internal hierarchy/order in the sets generated by the apparatus, represents a hierarchy/order of relevance of this information to the query/user request.

### BRIEF DESCRIPTION OF THE DRAWINGS

FIGS. 1 through 4 of the drawings depict a version of the current embodiment of the present invention for the purpose of illustration only. One skilled in the art will readily recognize from the following discussion that alternative embodiments of the structures and methods illustrated herein may be employed without departing from the principals of the invention described herein.

FIG. 1 is a block diagram illustrating the functional elements of a search apparatus and database incorporating the principles of the invention.

FIG. 2 is a flow chart illustrating the sequence of steps used by the apparatus in performing the described behavior.

FIG. 3 is a flow chart illustrating the flow chart of FIG. 2 in greater detail.

FIG. 4 shows the user display of the present invention.

### DETAILED DESCRIPTION OF THE PREFERRED EMBODIMENTS

In one aspect, the invention features a method for searching a database of records. The database can include Internet and premium content records (or any other set of labeled information records). In response to a search instruction from a user, the database is searched and a set of relevant meta-data elements (keywords for instance) is dynamically generated to provide the user with feedback on his query. These meta-data elements are presented as a relevance-ranked list (usually 20-50 long). The elements of this relevance feedback-list can be added to a new query, for instance by using hyperlinks. By default, terms can be added using the AND operator to achieve “intersection.” The mechanism can also perform queries containing NOT or OR operators to achieve “difference” or “union.” The interface can feature easy icons/buttons to add an element to the query with the AND, NOT or OR operator.

The method also generates a search result-list of relevant records from the database. The elements of this list can be hyperlinks that function as an input medium for the apparatus. The mechanism responds to selection of a record by adjusting database values and importance factors which are related to that record. This means that a record that is selected often can eventually rank higher in a result-list. Another response of the mechanism is the redirection to or fetching of the requested site/document or information. The length of the result list can be for example 200 (if available), but can be adjusted easily to other lengths. The interface can present the user a part of this result-list and provide links that lead to the presentation of other parts of the result-list. This can be done for example with an interval length of 10 results.

To present an accurate feedback list of meta-data elements, the collection of records used to generate the feedback list needs to be a valid sample of the total ‘population’ of records. A sample is ‘valid’ if the distribution of its records matches the distribution of the entire population of records. This means that if 10% of the records in the entire population contain the keyword “science”, a sample is valid if 10% of its records contain the keyword “science”. The mechanism determines how many records need to be processed in order to obtain a valid list of relevant meta-data elements and thus a valid representation of the subject context that is related to all records that match the user's query. During calculation of the feedback list, the rate of change in the ranking of all list-elements is continuously monitored. If this rate of change falls below a certain threshold value, the feedback list is considered to be of sufficient quality. Every processed record that matched the query contributes to a pre-result-list that is used in the next step of the process to generate the search result-list.

The feedback-list consists of the most relevant meta-data attributes within the collection of matching documents. To be able to calculate the feedback list, every record within the database has one or more associated meta-data attributes. These attributes are predicates that consist of either of a single term or of multiple terms in a Boolean expression. These terms can be parameters like author, keywords, subject, type, source, language characteristics, etc. An example of a predicate consisting of multiple words is ‘Kids’. This predicate can be constructed using the terms: ‘Toys’, ‘Hobbies’, ‘School’, ‘Adult’ from the keyword type and could lead to the predicate: ((Toys AND Hobbies AND School) NOT Adult). This means that selecting a single meta-data attribute (like “Kids”) from the feedback list can result in a complex query with several constraints on matching documents. This can include constraints on keywords, but also attributes like date, size, type, etc.

Every record has multiple scores, which are used to rank the records in a result list. One of these scores represents a record's popularity among other records. This is called link popularity and is measured by how often a record is referred to by other records in any relevant context. For example, if many documents dealing with basketball refer to the same document when talking about the rules of the game, this document will have a high popularity score in that context. Another score, called selection popularity, represents how often prior users have selected the record from a result-list in the past. For instance, if many people select the same document after viewing the results for a query on “basketball”, then this document will have a high selection popularity score.

The records in the result-list are ranked according to their final score. The invention features several techniques to influence this final score. The mechanism can apply an arbitrary combination of these techniques to obtain a final score.

One technique to influence a record's final score is to use the ratio between:

1. The summed weight of the various matching predicates (meta-data attributes) of a record, and

2. The summed weight of the predicates the query consists of.

This is a measure of how well the subject-context of a record matches the subject-context supplied by the user (query).

Another technique to influence a record's final score is to use its ‘context-score’. This score is a measure of how well the subject-context of a record matches the relevance feedback list, which represents the ‘average’ subject-context of all matching records. This means that records that are best matching with the relevance feedback list elements, will also rank highest in the search result-list. Another technique to influence a record's final score is to use its popularity scores described above. There are several other factors that can be used to influence a record's final score, such as the size of a document or the amount paid by the author to be ranked higher.

The invention features a thesaurus-like collection of items. Each item in this collection represents a predicate and consists of a number of data-elements that are used by the invention. All predicates in the database have one or more scores that can be used to influence the ranking of a predicate in the relevance feedback list.

One of these scores is a global weight. Every record consists of multiple predicates that contribute to the ranking process of both the relevance feedback-list and the search result-list. The global weight of a predicate can be used to influence the contribution that similar instances of a predicate have on these ranking processes. Another score can be used to influence how much weight a list of related predicates has on this predicate. Yet another score represents how often users have selected the predicate from a relevance feedback-list.

The predicates in the relevance feedback list are ranked according to a final score. The mechanism can use the different scores a predicate consists of and apply several different calculations to obtain the final score. For example, the invention limits the influence of occurrence when generating the relevance-feedback list. Some words occur very often while having a relatively low weight. This results in an “undeserved” high ranking in the feedback-list. To prevent this from happening, the weight of words that occur exceptionally often is re-calculated to reflect this. This is a process called “branching.”

Another data-element a thesaurus item consists of is a pre-compiled list of records that are associated with that item. The methodology first identifies the precompiled list of records that is associated with one of the query predicates and that is best suitable to use while generating the first result-list. By using this list and the complementary part of the query predicates (the rest), it can dynamically compile the first result-list, which matches the whole query and is a sub-set of the pre-compiled list.

The fact that the mechanism determines how many records need to be processed from a pre-compiled list (as long as there are still matching records available in the pre-compiled list) guarantees the availability of a valid relevance feedback-list and a complete search result-list. Both lists will be incomplete when the process only works with a subset of the last search result-list. This occurs in other systems that, contrary to the invention, use a fixed length starting search result-list to obtain sub-sets of this list in the next cycles of a narrowing down process. The invention first processes enough records to obtain a valid relevance feedback list and then takes the records that matched the query during that step of the process to generate a search result list. This requires the multi-pass processing of this list in case the search result-list is also ranked according to the matching ratio between the relevance feedback list and the records of the search result-list.

At certain points during execution of the method, a process called stemming is applied to the words of the search-request. Many words in a language have many forms in which they occur. Examples are single and plural forms, but also conjugations. Because in the vast majority of cases these different forms have the same semantic meaning, a mechanism is needed that recognizes these different forms and translates them to a common form. This is called the stem, although it is not necessarily the linguistic stem of a word.

The stem is rarely a linguistically correct word, so the method features a set of rules which are followed to determine what word the display processor should show when a (bucket) needs to be displayed:

1. When a user manually enters a word to add to a search-request, the displayed word should be that same word, regardless of the preferred form stored with that word's stem.

2. If the feedback generator selects a word to be displayed in the relevance feedback list, a pre-determined form is used. This form can be, for example, the form used most often in a reference-population of documents.

By way of example only, a certain stemming algorithm reduces both the words “computer” and its plural “computers” to “comput”. Because in a population of documents the word “computer” occurs more often than the plural form “computers”, the former is stored as the preferred form for the display-processor for the stem “comput”. However, when a user enters the word “computers” manually, the display processor should use that form instead. It should be noted that stemming is a language specific operation. An algorithm that performs well for English will in all likelihood fail for any other language. There are many different stemming algorithms for different languages.

Every predicate in the database can also have an attributed list of other related predicates. These lists can be used to influence the final configuration of the relevance feedback list that is presented to the user. Another possibility is the use of ‘sidesteps’. A sidestep is related to a certain predicate and provides the user with another predicate (or link) that is (closely) related to the predicate that is referring to the sidestep. This element is a software module and has been so identified merely to illustrate the functionality of the invention. By way of example only, it can be used to influence or tune a user's query. In a HTML interface like environment for example, a sidestep can be displayed on the user's screen when the user moves the mouse cursor over an item of the feedback list. This way a user is provided with feedback on what is relevant to the item the mouse cursor was on.

In another aspect, the invention features an information retrieval system or search apparatus for searching a database of records and this database itself. The database comprises a plurality of records, including Internet records and premium content records (or any other set of labeled information records).

The apparatus includes a database and an information retrieval system. The database includes different elements that all store a different part of a record when it is stored. These elements can be split into different intervals that can be distributed over different computers or storage media. The elements the database consists of are a meta-data allocation table, a record storage base, and a meta-data storage base. The information retrieval system includes an instruction parser, a token processor, a command processor, a stemming processor, a context processor, a record processor, a feedback generator, a result-list generator, a display processor, and a database manager. In the preferred embodiment, each of these elements is a software module. Alternatively, each element could possibly be a hardware module or a combined hardware/software module.

The information retrieval system receives search instructions from a user. Responsive to a search instruction, the information retrieval system searches the database to generate a search result list that includes a selected set of the records from the database. The information retrieval system also produces a list with relevant meta-data attributes (e.g. keywords) to provide the user with feedback on what is relevant to the records that matched the users query.

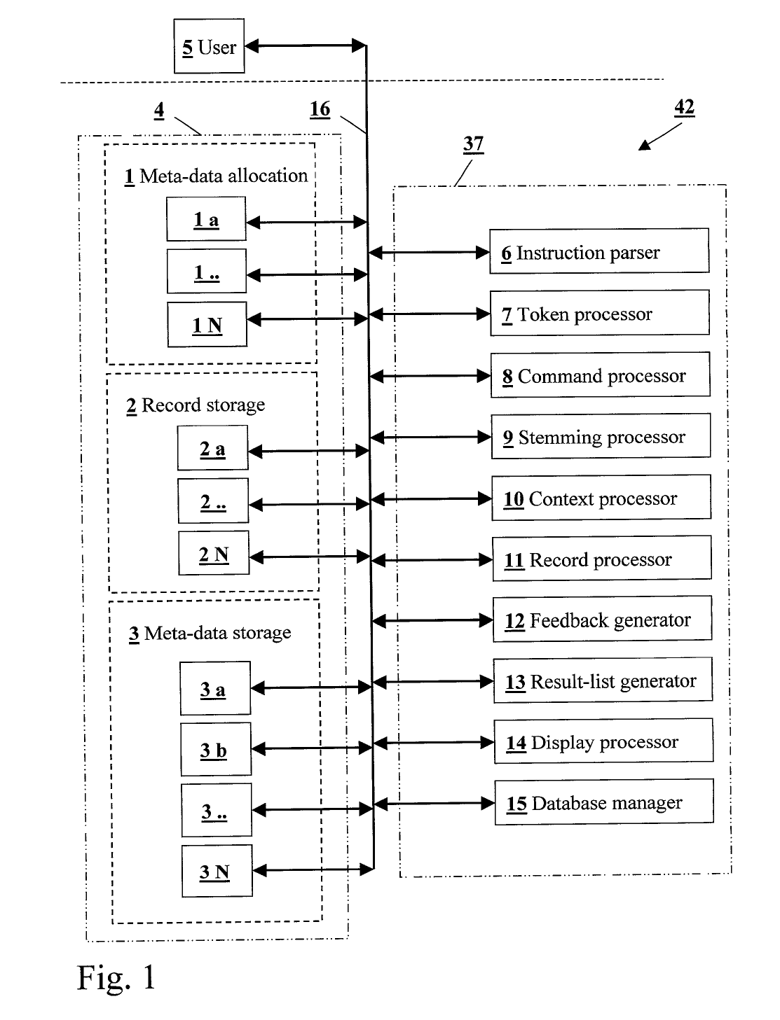

Turning to the drawings, FIG. 1 is a block diagram illustrating the functional elements of a search apparatus and database incorporating the principles of the invention. System 42 includes a database 4 and an information retrieval sub-system 37. The information retrieval sub-system 37 comprises an instruction parser 6, a token processor 7, a command processor 8, a stemming processor 9, a context processor 10, a record processor 11, a feedback generator 12, a result-list generator 13, a display processor 14, and a database manager 15. The database 4 consists of a meta-data allocation table 1, a record storage base 2, and a meta-data storage base 3. A user, 5 of the system/apparatus is coupled to database 4 and information retrieval system by system/apparatus I/O bus 16. These elements are software modules and have been so identified merely to illustrate the functionality of the invention.

System 42 performs a plurality of processes to dynamically create the search result list and the feedback list. These processes are generally described below with respect to FIG. 1. Instruction parser 6, token processor 7 and command processor 8 are used to transform the user request into one or more commands that can be used by the apparatus during the next steps of the search cycle. The instruction parser 6 takes the user request (the query) and parses it in order to obtain the different elements (tokens) of which it is constructed. The token processor 7 then identifies the different variables and instructions the user request comprises by selecting and sorting the tokens obtained from the instruction parser 6. The command processor 8 then determines if the generated command is a valid command. According to the type of command (i.e. search command or fetch command), the process continues. The database manager 15 takes care of updates of weights of predicates and records if necessary.

If the user request is a fetch request, System 42 fetches the requested information and calls a display processor 14 to display the information. If the user request is a search request, the stemming processor 9 determines the stem of every predicate. It therefore can use language specific characteristics to determine correct stems. The context processor 10 determines every sub-combination of predicates the query consists of that are present in the database. It then determines which precompiled list is best usable to select records from. The record processor 11 then processes the selected pre-compiled list of records that match the predicate (sub-combination) and selects the records that match all predicates which comprised the query. The feedback generator 12 then processes every selected record in order to generate a list of predicates that provide the user with feedback on what is (most) relevant to the selected records. The result-list generator 13 then processes the selected records to generate a ranked result-list. It uses the meta-data attributes of the selected records in order to sort the records in perspective to the (subject) context of the feedback list and the (subject) context of the query. The display processor 14 provides a graphical representation of the search or fetch process results for display on the user's monitor.

The meta-data allocation table 1 is used to store information about the location of the meta-data attributes included in the records in the database. The record storage base 2 is used to store the non-meta-data information included in a database record. The meta-data storage base 3 is used to store the meta-data attributes of a record in lists that concern records that are related in a certain aspect. The data-structures and algorithms the apparatus consists of are designed to allow the stored information to be distributed over multiple computers or storage media.

System 42 provides an efficient method to view and navigate among large sets of records and offers advantages over long linear lists. System 42 uses categorization to guide the user through a multi-step search process in a humane and satisfying way. A user can construct a complex query in small steps taken one at a time. Using System 42, a user can rapidly perform the search in a few steps without having to review long linear lists of records.

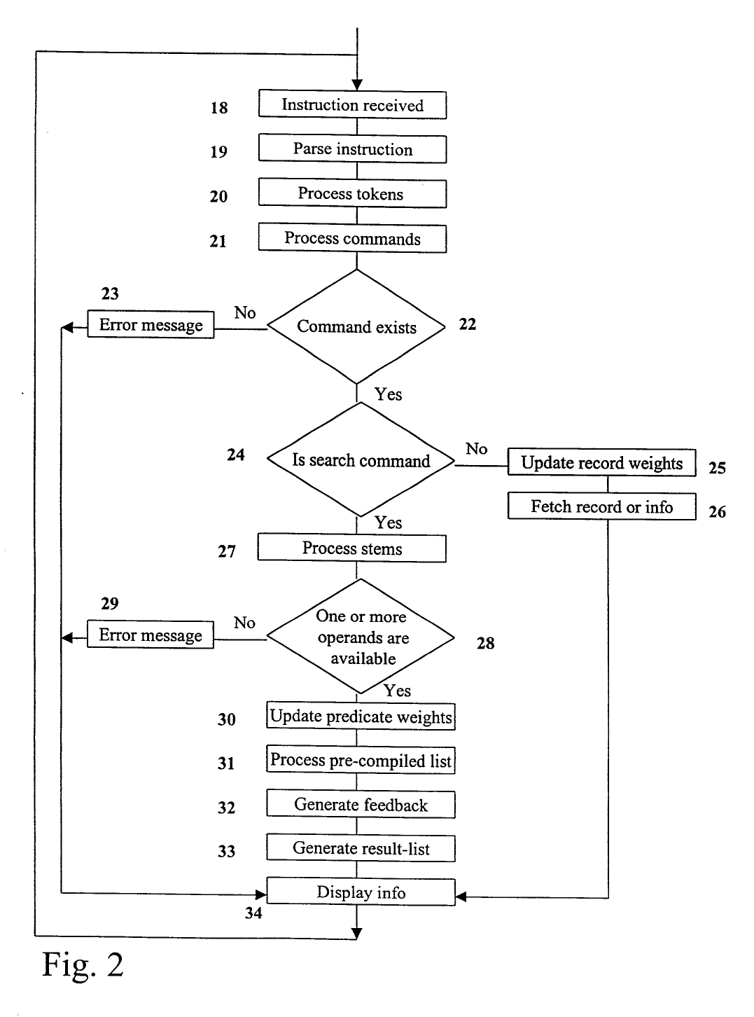

Turning to a more detailed discussion of the processes employed by Sytem 42, FIG. 2 is a flow-chart illustrating the detailed sequence of steps used by System 42 in performing the described behavior. With reference to FIGS. 1 and 2, the information retrieval system 42 retrieves an instruction (e.g. a query) from the user 5 via the I/O bus 16 (step 18). The instruction parser 6 receives the instruction (step 18) and produces a set of tokens from the instruction (step 19). The token processor 7 processes every generated token (step 20) and determines the type of every token. This is a categorization process that sorts tokens into variables (e.g. keyword or addresses) and instructions (e.g. search instruction or fetch document instruction) if possible. This step thus sorts every term to its meaning. The command processor 8 processes the resulting set of variables and instructions (step 21) in order to generate valid commands to use in the next steps of the process.

The command processor 8 then checks whether or not the generated commands do exist (step 22). If not, it generates an appropriate error message (step 23) for the display processor 14 to process (step 34) and respond to with an appropriate message to the user. If the command exists, the command processor 8 checks if it is a search command or a fetch command (step 24). If it's a fetch command the database manager 15 determines the updates it has to do to the record weights (step 25). After that, the database manager 15 fetches the requested record or information (step 26) and the display processor 14 takes care of the rest of the displaying process (step 34). If the generated command is a search command, the stemming processor 9 determines the correct stem of every predicate when necessary (step 27). Stemming is performed with the keyword terms a predicate consists of. The stemming processor uses the language characteristics of a query (specific query variables) during this process. The context processor 10 determines whether or not predicates are included in the database and determines the most suitable pre-compiled list of records to use during record processing (step 28).

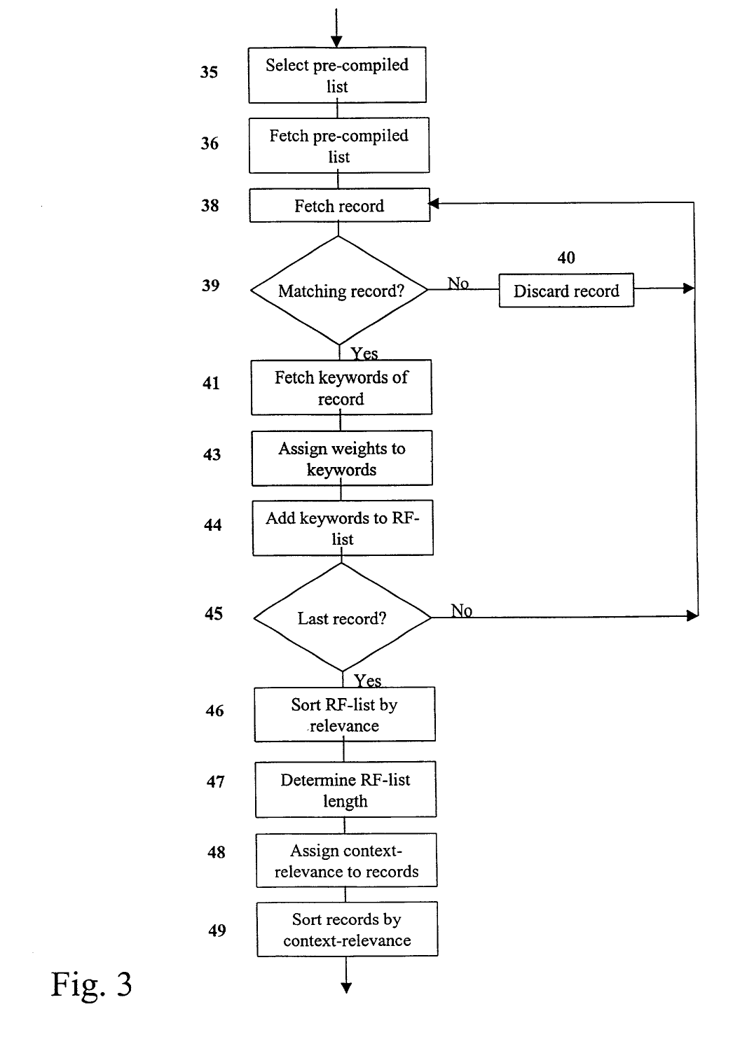

After this, the database manager 15 determines the updates it has to perform on some predicate weights (step 30). Then, the record processor 11 processes as many records as necessary (if available) to obtain a valid sample of the distribution of meta-data attributes of records that match the query (step 31). In the next step, the feedback generator 12 generates a list of predicates that provide the user with feedback on what predicates are relevant to the records that matched the users query (step 32). The result-list generator 13 then processes a result-list (step 33) using the list of records that was generated during the record processing (step 31). In this process every record is ranked using the weights of its predicates and the distribution of query predicates and feedback-list predicates. In the final step of the search cycle, the display processor 14 displays all results to the user (step 34). FIG. 3 is a flowchart illustrating in greater detail the sequence of steps 31, 32 and 33 from FIG. 2. With reference to FIGS. 2 and 3, the Information Retrieval system receives from the preceding steps a valid search-instruction. The context processor 10 selects the pre-compiled list based on performance (step 35). It then fetches the selected list, either from hard disc or from RAM (step 36). The record processor 11 fetches the first record in the pre-compiled list (step 38), and checks whether it matches the complementary part of the query (step 39). If the record does not match the query, it is discarded (step 40) and the next record is processed. If the record does match the query, the record processor 11 fetches all keywords associated with that record (step 41). Each of these keywords is assigned a weight indicating the relevance of that keyword to that record (step 43). Then each keyword is added to the unsorted relevance feedback list (step 44) or, if that word is already present in the list, its weight is increased.

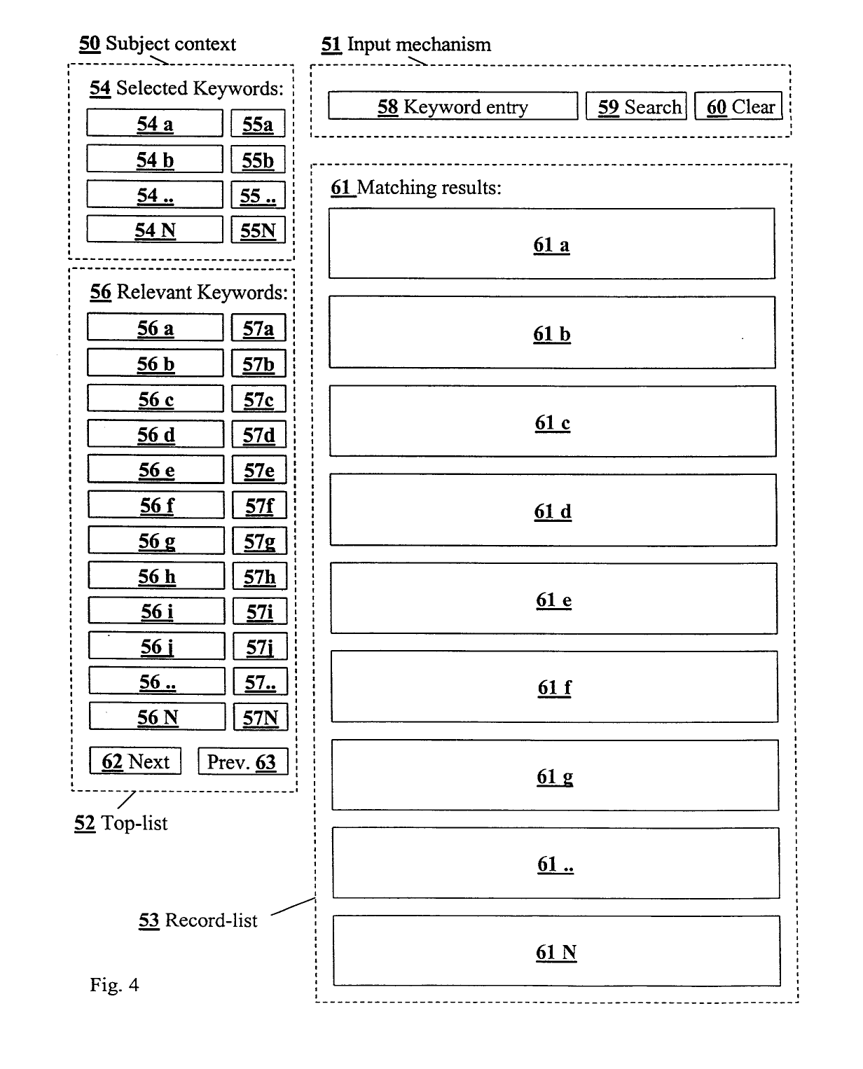

The record processor 11 checks if the processed record is the last one in the precompiled list and continues with the next record if this is not the case (step 45). If the last record is processed, the feedback generator 12 compiles a final list from the unsorted relevance feedback list (step 46). The result-list generator 13 then determines a length (i.e. number of items) for the RF-list (step 47), and assigns each matching record processed by the record processor 11 a weight indicating the similarity between each record's context and the context described by the final feedback list (step 48). The result-list generator 13 then compiles a final result-list containing the matching records in a useful order (step 49). FIG. 4 is a sample illustration of a user's display during a search using the System 42. This illustration is merely exemplary and provided solely for explanation purposes. Therefore, the layout of the various keys, buttons and icons is immaterial. With reference to FIG. 4, the display (search interface) can be divided into four elements, 50, 51, 52 and 53, that are designed to function as complements to each other. Leaving one of these elements out of the interface would prevent the total mechanism to function through the refinement process as designed.

System 42 uses a ‘tool’ called ‘top-list’ (52), that features an intuitive visual point and click system. This tool is displayed every cycle in the search process and provides the user a system to refine his search “instruction.” The subject context that is displayed by the ‘top-list’ module is usually built of keywords and covers a set of entries that is a subset of the total databases. As a response to a users input (through the top-list tool), System 42 reacts by creating a search instruction that is used to search the database. The invention uses both the user input and information from the database (the subset of matching entries) to generate the information that is provided to the user. The elements 50, 51, 52 and 53 are used to provide the user this information.

Element 51 is a sentence-like representation of the user's interests. Usually this is in the form of an edit box and a string (standard HTML-form input box like structure that consists of the search words). Element 50 is a representation of the user's interests in the form of subject context. Usually this is a list of the search words or keywords already used by the user in the current cycle of the search process. Element 52 is a representation of a subject context related/complementary to the users interests in the form of a list of keywords (top-list). The items of this list can function as search word suggestions and provide the user with feedback on what is relevant to the records that matched his query/user request. Element 53 is a list of records that is ranked to match the users interests (result list). The top-list module displays element 50 and 52.

System 42 uses a search instruction to produce the above information from a custom database. The data structures and properties of this database are designed to match the specifications of System 42.

The information that is provided to a user is designed to also function as an input medium (or input processor) for the next cycle in the search process. As result of a user response, the input medium produces a search or ‘deliver’ instruction for System 42, which then produces the next cycle of the search interface.

Both the search and the ‘deliver’ instructions can be used by System 42 to influence the status of database 4. The parameters that can be tuned consist of both database system and entry parameters. The values of these parameters have an influence on the relation between the entries in database 4. This means that System 42 can respond on the input with adjustments of the values in the database. In other words, System 42 can learn.

Referring again to FIG. 3, a user can submit information that will be used to generate a search instruction or a user can submit information that will be used to generate a deliver instruction. This results in jumping to or fetching the requested Internet or premium content (or other information).

A user can submit the information that is used to create the search instruction in a few different ways. The first is by using the edit box 58; the second is by using the top-list tool that is constructed of elements 50 and 52.

When a string is submitted using the edit box 58, a string ‘filter’ tries to extract ‘useful’ keywords from it that represent the user's interests. The filter discards multiple instances of the same word and it ignores ‘stop’ words like: ‘in’, ‘the’, ‘and’, etc. It also tries to interpret the ‘base’ root of a word. This means that it takes care of conjugations of a word like plural/singular forms, etc. Another function could be an automatic spell checker, which can make suggestions about other ways to spell a word.

The top-list tool consists of two parts (50 and 52) that both contain keywords: a search words part and a top-list part (feedback list). The top-list part consists of keywords or other meta-data attributes that describe the subject context closest related to the search instruction. When a keyword in the top-list is clicked, it is added to the search instruction which is then used to generate the next output cycle. This next output cycle represents a revised version of the last cycle. The search word part is a set of keywords that describes the user's interests. The words in this part represent the search instruction and can be the result of either submitting a string with the edit box or clicking a word in the top-list part. Functionally, this set represents the question a user has and is a presentation of the user's interests. A user can always decide to remove a word from the search words list by clicking the remove option next to the word, which also results in a new output cycle.

The search instruction that is generated using one of the above described submit routes, is used by the apparatus to generate the next output cycle.

The deliver instruction results in jumping to or fetching the requested Internet or premium content. Before the delivery takes place however, System 42 can use the instruction to influence the status of database 4. A user's decision to choose a certain entry can result in a revised weighting factor of that entry in database 4 or even in a changed database system parameter. This means that subsets of a certain type all will be revised.

Element 51 represents a standard input field comprised of elements 58, 59 and 60. Element 58 is a search field into which a user can enter search instructions. A search icon 59 is used for executing the search instructions. The display can also include one or more hint icons 60 for providing search tips, miscellaneous function icons (e.g., a search icon, clear icon, a support icon, etc.) and search icons (e.g., simple search, advanced search, or specific searches like file, video or music search).

Element 50 represents the search-words and is comprised of elements 54 and 55. Element 54 represents the search terms (meta-data attributes or predicates) already used in the query at that moment. Element 55 represents a button/icon that can be used by the user to remove or delete a search term from the query.

Element 52 represents the top-list and is comprised of elements 56, 57, 62 and 63. Element 56 represents the terms (meta-data attributes or predicates) comprising the feedback list (toplist). Element 57 represents one or more buttons or icons that can be used to add a toplist item to the query using the ‘AND’ or ‘OR’ operator. Element 62 and 63 are buttons or icons that can be used to display the previous or next twenty to fifty meta-data attributes from the feedback-list, if available.

Element 53 represents the result list and is comprised of element 61, which represents one or more records matching the users query.

System 42 is built around a data structure designed specifically for this purpose. On a high level, the structure consists of a thesaurus of words and a collection of records. Each word in the thesaurus is contained in a “bucket”. The bucket contains all information specific for that particular word, like the word itself, how often it occurs, where it is located in the database, etc. etc.

Each record refers to a document, possibly on the Internet. A record contains the title, description and URL (a.k.a. internet-address) of that document. It also contains references to words in the thesaurus that together describe the subject of the document (the document- or record-context). This list of references is called a record's meta-information.

The basic principle is contained in a design that allows rapid matching of a thesaurus-word to the entries that contain references to it, and rapid generation of a feedback-list. This design is the result of the following requirements which are rapidly carried out by the data-structure:

1. Access the bucket containing a specified word.

2. Match relevant entries to query-words.

3. Build a feedback list.

These requirements are satisfied respectively by the following constructions:

1. The array of words in the thesaurus is ordered in a Hash-table structure. This means that a program knows immediately which element in the array contains the desired word, instead of having to linearly search through the array.

2. A bucket contains a reference to a list of entries that contain this bucket in their meta-information. This list is referred to as the record-list. It means that a program has immediate access to all entries referring to a specified word.

3. In certain alternate embodiments of the algorithm, the entries in the record-list associated with a bucket all contain the full meta-information. These references are used to identify which words are most common and/or most important in the set of matching entries.

Point three allows part of the information to be stored on a hard disc. One embodiment of the algorithm stores all buckets in RAM, while the record-lists associated with each bucket and the record-information are stored on a hard disc.

The record list of a bucket is a lot smaller if a reference to the record is stored, as opposed to the entire meta-information of each record. If data is to be stored completely in RAM, this is the preferred option. However, while a hard disc is fast at retrieving information once it is found, it is extremely slow at locating information. Therefore, an alternate system embodiment using a hard disc should be configured to look for information as infrequently as possible by having the entries in the record-list associated with a bucket all contain the full meta-information described in construction three, above.

When System 42 receives a search-command, a sequence of actions is started that results in the generation of a result-list and a feedback-list. A query consists of one or more query-words. These words can have an “AND”, “NOT” or “OR” operator attached to it. The query-sequence consists of the following steps, which are explained in more detail below:

1. Find the buckets containing the specified query-words.

2. Using the information in each bucket, determine which record-list should be used. This may be the record-list of the least occurring word, or the result of another criterion.

3. For each entry in the record-list, check if it satisfies the query.

4. Create a feedback-list item for each bucket referenced by one or more records in the record-list.

5. Each feedback-list item is assigned a cumulative weight that is the sum of the weight it has for each item that refers to it.

6. Each entry is assigned a cumulative weight that is the sum of the weights of a record's query-words.

7. Perform branching. This ensures small but important categories are not outweighed by large, less important categories.

8. Sort the items in the feedback-list according to their cumulative weight.

9. Sort the records in the result-list according to their cumulative weight.

Step 1: Steps preceding the actual execution of the query result in a list of words that together describe the information needs of the user. Each word is processed by a stemming-algorithm that attempts to catch different conjugations of words. For example, searches for “computers” and “computer” will yield the same results. The display processor at the end of the pipeline ensures the appropriate word is displayed.

Step 2: The algorithm attempts to optimize the process by minimizing the amount of records that need to be retrieved and processed. However, simply retrieving the shortest record-list does not work. For queries consisting only of “AND” words, the shortest record-list is selected. Record-lists of words with the “NOT” operator are never used. Record-lists of words with the “OR” operator are all used.

Step 3: A query consists of words logically linked with the “AND”, “OR” or “NOT” operators. A record satisfies the query if its collection of meta-data elements matches the query-predicate.

Step 4: Every bucket contains a number, which is the ID of the query that last accessed that bucket. Every query has its own unique ID, and when accessing a bucket, the current query uses this ID to check whether it already accessed that bucket. If this is not the case, a new feedback-list item is created. If a bucket was already accessed earlier during the current query, the weight of the appropriate feedback-list item is adjusted appropriately.

Step 5: Each reference to a bucket also contains a weight. This indicates how important that particular word is for the subject of that particular document. For example, if 3 records reference the word “Car”, these records can all assign a different weight to it (e.g., 2, 3 and 100). The sum of these different weights is the cumulative weight of “Car” (in this case 105). This cumulative weight determines the position of the word “Car” in the feedback-list (Step 8).

Step 6: Suppose a query consists of the words “Car”, “Windshield” and “Tire”. The meta-information of a certain record references these words (amongst others) and assigns weights 20, 15 and 10 to them respectively. The cumulative weight of that record is the sum of these weights (In this case 45). The cumulative weight determines the position of a record in the result-list (Step 9).

Step 7: The feedback generator takes the list of all keywords that occur in the collection of matching items. It compiles from this list a shorter list with keywords describing the “average” context of all matching records. This may be a simple sorting by relevance, but other mechanisms are conceivable.

Step 8: To prevent keywords that occur exceptionally often from ending up too high in the feedback-list, despite a low relevance to a query, the feedback generator performs a statistical analysis of the keywords. The average occurrence is calculated, as is the standard deviation of the occurrence. If a keyword occurs more than the average plus the standard deviation, its weight is recalculated to lessen the influence of its occurrence.

Step 9: The result-list generator produces a list of records that satisfy the query, and sorts them so that the most relevant are placed on top. This relevance can be determined relative to the query, or relative to the feedback-list. For very general queries, it is usually best to sort the result-list by relevance to the feedback-list. It is likely that in these cases the feedback-list contains keywords that are useful to narrow down a search, so sorting should place on top the documents that match the probable next step in the iterative search-process. For specific queries, the result-list should be sorted by relevance to the query itself.

The foregoing discussion discloses and describes merely exemplary methods and embodiments of the present invention. One skilled in the art will readily recognize from such discussion that various changes, modifications and variations may be made therein without departing from the spirit and scope of the invention. Accordingly, disclosure of the present invention is intended to be illustrative, but not limiting, of the scope of the invention, which is set forth in the following claims and their legal equivalents.

I claim:

1. A method for searching a database based upon a search instruction having at least one term, comprising:
selecting a pre-compiled list of records associated with at least one of the terms of the search-instruction;
processing the selected pre-compiled list to: (i) identify records matching the search-instruction; (ii) compile a feedback-list of meta-data attributes associated with the records matching the search-instruction, and; (iii) assign each meta-data attribute in the feedback-list with a weight reflecting its relevance to the records matching the search instruction;
processing the feedback-list in order to obtain a partial list comprising meta-data attributes which are most relevant to the records matching the search-instruction, and;
weighting the records matching the search-instruction according to relevance to either the feedback-list or the search-instruction or both.

2. A method according to claim 1 further comprising weighting and ranking the records within the search results list according to pre-selected relevancy criteria.

3. A method according to claim 1 further comprising identifying keyword, subject, type, source, language characteristics associated with each record within the search result list.

4. A method according to claim 3 further comprising grouping the meta-data attributes in the feedback-list in response to a user-selected value for one of the characteristics.

5. A method according to claim 1 further comprising selecting meta-data attributes in the feedback-list as a function of the identified common characteristics of the records.

6. A method according to claim 5 further comprising selecting between about twenty to fifty meta-data attributes to be included in the final feedback-list.

7. A method according to claim 1 wherein the database includes Internet records, premium content records or other labeled content.

8. A method according to claim 1 further comprising providing a graphical representation of the meta-data attributes in the feedback-list.

9. A method according to claim 1 further comprising updating the weights of the records and meta-data attributes in the database in response to the search- or fetch-instruction.

10. A search apparatus for searching a database based upon a search instruction having at least one term, comprising:
an instruction parser, a token processor, a command processor, a stemming processor and a context processor for interpreting a query and selecting an appropriate pre-compiled list of records associated with one or more terms of the search-instruction;
a record processor for processing the selected pre-compiled list to: (i) identify records matching the search-instruction; (ii) compile a feedback-list of all meta-data attributes associated with all records matching the search-instruction, and; (iii) assign each meta-data attribute in the feedback-list with a weight reflecting its relevance to the records matching the search instruction;
a feedback generator for processing the feedback-list to generate a list comprising meta-data attributes which are most relevant to the records matching the search-instruction; and
a result list generator for weighting the records matching the search-instruction according to relevance to either the feedback-list or the search-instruction or both.

11. An apparatus according to claim 10 further comprising means for ranking the records within the search result list according to pre-selected relevancy criteria.

12. An apparatus according to claim 11 further comprising means for grouping the records within the search result list in response to a user-selected value for one of the characteristics.

13. An apparatus according to claim 10 further comprising a record processor for identifying subject, type, source and language characteristics associated with each record within the search result list.

14. An apparatus according to claim 13 further comprising means for ranking the identified common characteristics of the records into a hierarchical order.

15. An apparatus according to claim 10 further comprising means for selecting between about twenty to fifty meta-data attributes to be included in the final feedback-list.

16. An apparatus according to claim 10 further comprising a display processor for providing a graphical representation of the meta-data attributes.

17. An apparatus according to claim 10 further comprising means for generating, as a function of one of the meta-data attributes, a refine instruction being representative of an additional instruction for searching the database for records associated with the meta-data attributes and the additional instruction.

18. An apparatus according to claim 10 wherein the database includes Internet records, premium content records and other content.

19. An apparatus according to claim 10 further comprising a database manager for updating the weights of the records and meta-data attributes in the database in response to the search- or fetch-instruction.

20. An apparatus according to claim 10 further comprising a display processor for providing a graphical representation of the categories to the user.
